(19) United States
(12) Patent Application Publication
(10) Pub. No.: US 2026/0312813 A1
(43) Pub. Date: Oct. 8, 2026

(54) Systems and Methods for Creating a Verified Web Using Blockchain Domains, AI Agents and Verified Resolutions Using Metadata and Proofs

(71) Applicant: Prem Makeig, Belfast, ME (US)

(72) Inventor: Prem Makeig, Belfast, ME (US)

(21) Appl. No.: 19/561,465

(22) Filed: Mar. 9, 2026

Related U.S. Application Data
(60) Provisional application No. 63/743,277, filed on Jan. 9, 2025.

(51) Int. Cl. H04L 9/32; G06F 21/62; H04L 9/00

(52) U.S. Cl. CPC H04L 9/3218; G06F 21/6245; H04L 9/3236; H04L 9/3247; H04L 9/50

(57) ABSTRACT

A unified framework is disclosed for creating a Verified Web that integrates blockchain domain resolution, cryptographic proofs, and Verified AI Agents. The system merges trust-scored resolution APIs (“Unruggable Resolve”) with a cross-chain data gateway (“Unruggable Gateways”) to retrieve data from multiple blockchains and off-chain sources. Cryptographic proofs anchor domain records, user credentials, and AI Agent workflows, ensuring tamper-resistant authenticity while preventing malicious resolver switching. The framework accommodates local or cloud-based Large Language Models (LLMs), enabling clients to dynamically assemble Verified AI Agents from verifiably sourced metadata. By mitigating AI-generated misinformation and supporting unstoppable name resolution, the solution fosters a robust ecosystem of decentralized, multi-chain applications, strengthening trust, security, and interoperability across evolving blockchain and AI landscapes.

### CROSS-REFERENCE TO RELATED APPLICATIONS

This application claims the benefit of U.S. Provisional Application No. 63/743,277, filed Jan. 9, 2025, the entire disclosure of which is incorporated herein by reference.

### FIELD OF THE INVENTION

This invention relates generally to blockchain technology and, more particularly, to systems and methods for creating a Verified Web by leveraging blockchain domains, cross-chain data resolution, proof verification, metadata-driven domain records resolution, and AI agents.

### BACKGROUND OF THE INVENTION

Blockchain domain name systems, such as the Ethereum Name Service (ENS), provide human-readable names that map to blockchain addresses and other resources. ENS functions similarly to the Domain Name System (DNS) for the traditional internet but includes additional blockchain-specific capabilities. ENS supports various record types, including address records, content hashes, text records, and service records, allowing for diverse data such as IPFS hashes, raw bytes, or external service identifiers to be associated with names. Its architecture consists of several main components: a Registry Contract that maintains all domains and subdomains, Resolver Contracts that map names to addresses or other data, and Registrar Contracts that govern domain allocation. This hierarchical structure enables the creation of subdomains (e.g., sub.example.eth) and supports advanced resolution logic.

With the advent of Ethereum Layer-2 (L2) solutions, many users now store essential data off the main Layer-1 (L1) chain. L2 networks reduce gas costs and increase throughput by using rollup technologies that periodically commit state roots to Ethereum. These rollups may be optimistic, employing interactive fraud proofs, or zero-knowledge (ZK), relying on cryptographic proofs directly verifiable on L1. Despite these advancements, resolving ENS or other blockchain domains when data resides on different blockchains or off-chain sources remains complex. While the ERC-3668 “CCIP Read” standard introduced a framework for off-chain data retrieval, no universal solution exists for trustless and verifiable cross-chain resolution.

Compounding this challenge is the rise of synthetic content, deepfakes, and AI-generated text and media. Malicious actors can easily swap resolvers to falsify on-chain records, undermining trust in identity credentials, domain data, or the provenance of user media. Current systems lack straightforward, auditable methods to track resolver authenticity and ensure unstoppable domain resolution. These vulnerabilities jeopardize the integrity of blockchain-based identity systems and content verification processes.

To address these challenges, the present invention introduces two integrated solutions: “Unruggable Resolve” and “Unruggable Gateways.” Unruggable Resolve provides trust-scored blockchain domain resolution through audited resolvers, metadata, and cryptographic proofs, enabling secure and transparent resolution. Unruggable Gateways offers a cross-chain data resolution architecture that facilitates secure, proof-based fetching of domain data from other chains or off-chain sources. Together, these systems enable a Verified Web where users, media, and content can be cryptographically verified across origin chains and L2 environments, enhancing trust, security, and interoperability in decentralized ecosystems.

AI agents are sophisticated programs designed to autonomously execute multi-step tasks by leveraging large language models (LLMs) and structured workflows. These agents integrate various tools and processes, enabling them to handle complex interactions, retrieve external data, and make decisions based on dynamic inputs. At their core, AI agents operate by orchestrating a series of interconnected actions that may include querying APIs for data, identifying triggers from user inputs, and executing predefined workflows tailored to specific scenarios.

For instance, if a user communicates an issue with an order, the AI agent can detect this intent and activate an “order issue” pathway. In this pathway, the agent searches for relevant company policies or return procedures, integrating this information into the LLM's pre-context. The pre-context, a critical component of the LLM query, enriches the model's understanding by providing domain-specific knowledge, enabling it to deliver precise and context-aware responses to the user's problem. This dynamic assembly of context ensures that the LLM operates within a well-informed framework, optimizing its ability to address the issue effectively.

AI agents can also leverage Retrieval-Augmented Generation (RAG) techniques, which use a vector database to retrieve and integrate “chunks” of relevant information as additional context for LLM queries. By indexing data as vectors, RAG ensures high accuracy in retrieving pertinent knowledge, enhancing the agent's capability to answer complex queries or provide detailed assistance.

The development and deployment of AI agents often involve programming languages like Python or JavaScript/TypeScript, providing developers with flexibility to create bespoke workflows, integrate APIs, or execute advanced functions. Alternatively, no-code and low-code platforms are increasingly popular, offering accessible tools to construct AI agents without extensive programming knowledge. These platforms enable users to design knowledge bases, implement RAG workflows, and define step-by-step interaction paths. Such paths may involve gathering user inputs, querying cloud-based LLMs (e.g., OpenAI GPT models), or leveraging local models like LLama for privacy-centric or edge deployments.

AI agents are not limited to traditional data retrieval or response generation. They can also interact with decentralized systems by accessing blockchains via Remote Procedure Call (RPC) servers. This functionality allows agents to read from blockchains, validate transactions, and even sign transactions programmatically, making them invaluable in scenarios requiring on-chain interactions. For example, an AI agent could assist in managing decentralized finance (DeFi) portfolios, verifying smart contract interactions, or facilitating crypto payments.

The versatility of AI agents lies in their ability to combine diverse technologies and processes into seamless workflows. By integrating LLMs, RAG, APIs, and external systems such as blockchains, they serve as dynamic, multi-functional tools capable of addressing a wide range of applications—from customer service automation to blockchain-based financial operations—while maintaining adaptability and efficiency in rapidly evolving technological landscapes.

AI Agents are autonomous entities designed to perform tasks, make decisions, and generate human-like responses using Large Language Models (LLMs) as their core computational engine. These LLMs, such as OpenAI's GPT or Google's PaLM, are trained on vast amounts of text data and rely on prompts to initiate output generation. By employing triggers—specific events or keywords that activate targeted functions—the agent can respond precisely to user queries. To handle extensive or complex inputs, data is often segmented into chunks, ensuring more efficient retrieval from a knowledge base. Within these systems, embeddings provide a numerical representation of text in a vector space, enabling semantic search and contextual matching. The size of the context window further determines how much prior or surrounding information the LLM can process at once, while API integrations allow these agents to interface with external services, databases, or workflows.

Building robust AI Agents involves various design strategies and tools. Agent frameworks (e.g., LangChain, Rasa) and an orchestration layer coordinate different modules, from input parsing to output generation. To accomplish complex goals, developers rely on task decomposition, where large objectives are broken into smaller, manageable subtasks that form the agent's action plan. Throughout this process, Retrieval-Augmented Generation (RAG) ensures accuracy by pulling relevant data from a knowledge graph or other structured repositories, while zero-shot and few-shot learning methods enable the agent to adapt to new tasks with minimal examples. Advanced techniques, such as Chain of Thought (CoT) reasoning, improve performance on intricate queries by making the agent's step-by-step thought process explicit. Meanwhile, memory capabilities preserve a session state, fostering continuity across multiple interactions, and supporting intents and entities extracted during Natural Language Understanding (NLU). In addition, multimodal input support empowers the agent to handle text, images, or audio simultaneously, leveraging Natural Language Generation (NLG) to produce coherent, contextually rich responses.

To maintain reliability and quality, AI Agents incorporate mechanisms like feedback loops to refine responses based on user evaluations, fallback mechanisms to provide default outcomes when queries cannot be resolved, and grounding procedures to prevent hallucination by anchoring outputs in verified data sources. Developers can further shape the agent's persona to align with the brand, tone, or style of a given application. By continuously monitoring and updating the workflow, these systems remain agile and adaptable in real-world settings.

Ultimately, robust AI Agent development involves orchestrating these elements—LLMs, knowledge bases, triggers, action plans, embeddings, and more—to deliver efficient, contextually grounded, and user-centric services.

Semantic vector databases are specialized storage systems that manage and retrieve data based on semantic meaning rather than traditional keyword-based indexing. They use large language models (LLMs) to “vectorize” data, converting content such as text, images, or audio into high-dimensional vectors that encode its semantic essence, enabling similarity-based searches that go beyond exact matches. By generating embeddings—numerical arrays representing contextual and semantic attributes—LLMs allow these databases to efficiently retrieve semantically relevant entries using measures like cosine similarity or dot products. This capability is particularly powerful for unstructured data and is integral to Retrieval-Augmented Generation (RAG) workflows, where vectors provide fast, scalable access to relevant information fed into the pre-context of LLM queries, enhancing domain-specific responses. Vector databases can also index multimodal data, combining text and image embeddings for broader applications, making them essential for search engines, recommendation systems, customer support agents, and knowledge retrieval platforms that demand efficiency and semantic relevance.

Retrieval-Augmented Generation (RAG) can be implemented using numerous methods to retrieve relevant information from diverse sources, including vector databases where data can be preprocessed into high-dimensional embeddings by large language models (LLMs) or similar systems, allowing semantic similarity searches by comparing vectorized queries to stored embeddings. Web searches can dynamically query public or private resources using APIs like Google Search or Bing, while GraphQL APIs and SQL databases can fetch structured and relational data for granular, domain-specific queries. For unstructured or document-based systems, NoSQL databases like MongoDB or Couchbase can handle hierarchical or schema-flexible queries, and file-based retrieval systems, such as searching through PDFs, Word documents, or spreadsheets, can be paired with optical character recognition (OCR) to digitize and index content.

Hybrid approaches can combine multiple sources, such as vector databases for semantic relevance, APIs for real-time updates, and knowledge graphs or ontologies to retrieve and map entities and relationships for enriched context. Event-driven systems can integrate real-time data streams, such as IoT sensor logs or transactional updates, while specialized solutions can include custom APIs for proprietary data like inventory, customer interactions, or financial metrics.

These various methods ensure RAG workflows can adapt to a wide range of applications, providing enriched and accurate contextual data for large language models to generate domain-specific, contextually aware, and highly relevant responses.

### SUMMARY OF THE INVENTION

The invention offers a comprehensive solution for establishing a Verified Web by integrating Unruggable Resolve, an API that resolves blockchain names with metadata, and proofs. Unruggable Gateways are used to resolve names securely cross-chain from L2s. This combined system secures on-chain identity, verifies media authenticity, and ensures metadata integrity across multiple blockchains and off-chain databases. Unruggable Resolve provides a single API for resolving blockchain names, such as ENS, and returns metadata along with optional cryptographic proofs, allowing clients to validate the authenticity and safety of resolved data. By consolidating multiple resolution mechanisms into one service, the system simplifies the use of blockchain domains while enhancing security and reliability.

Unruggable Gateways allows for seamless cross-chain interactions. The gateway architecture retrieves data from Layer 2 networks or off-chain sources, generates cryptographic proofs, and verifies them on the origin chain using specialized verifiers. It incorporates CCIP-Read logic to handle off-chain lookups while ensuring the results can be trustlessly validated on-chain. Unruggable Resolve, an API service, with generated proofs needs a verifier in order to verify the proofs. One solution is to use an audited resolver registry that allows clients to use only trusted, immutable resolvers to prevent fraudulent changes, such as malicious domain owners switching to deceptive resolvers. This protects blockchain-based name systems from manipulation and strengthens trust in domain resolution.

The invention also addresses the growing challenges posed by AI-generated misinformation and synthetic content. By resolving content with cryptographic proofs-such as Merkle proofs, zero-knowledge proofs, hashes, or signature-based attestations-the system enables the verification of text, images, and videos. Provenance data is stored on-chain to ensure tamper-resistance, mitigating the risk of deepfakes and synthetic media manipulation. Together, these tools create a robust infrastructure for trustless or trust-minimized domain resolution, secure cross-chain interactions, and verified content authenticity, addressing critical needs in a rapidly evolving blockchain and AI landscape.

### BRIEF DESCRIPTION OF THE DRAWINGS

FIG. 1A shows the first image of three images, showing the steps of resolving an ENS name using ENSIP-10, CCIP-Read, and Unruggable Gateways.

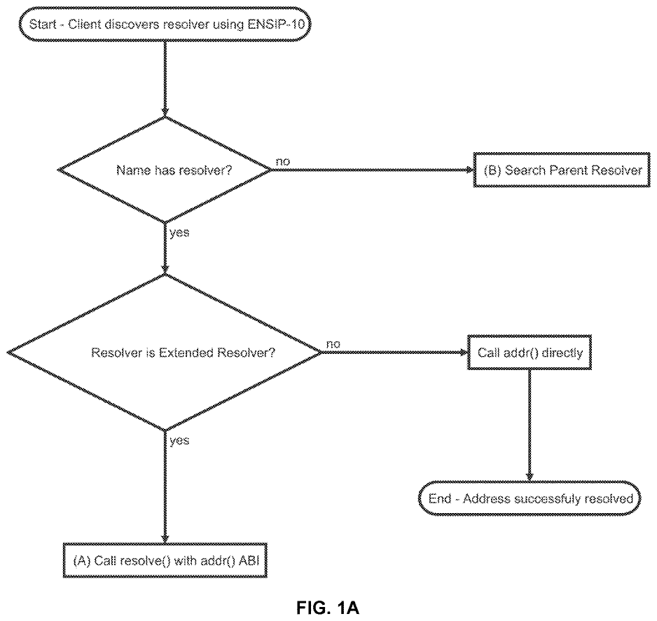

FIG. 1B shows the second image of three images, showing the steps of resolving an ENS name using ENSIP-10, CCIP-Read, and Unruggable Gateways.

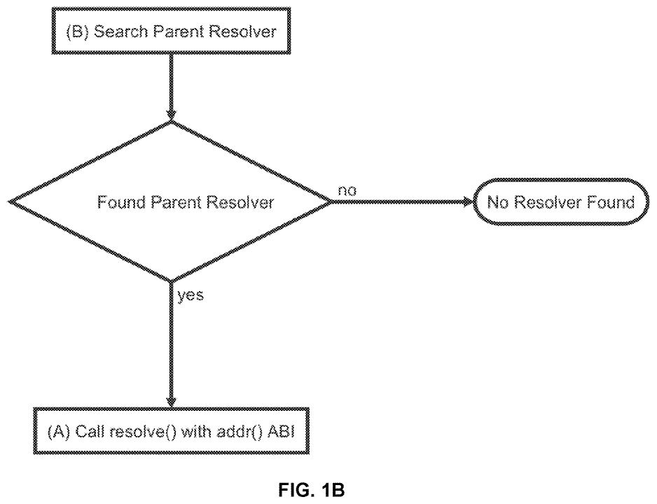

FIG. 1C shows the third image of three images, showing the steps of resolving an ENS name using ENSIP-10, CCIP-Read, and Unruggable Gateways.

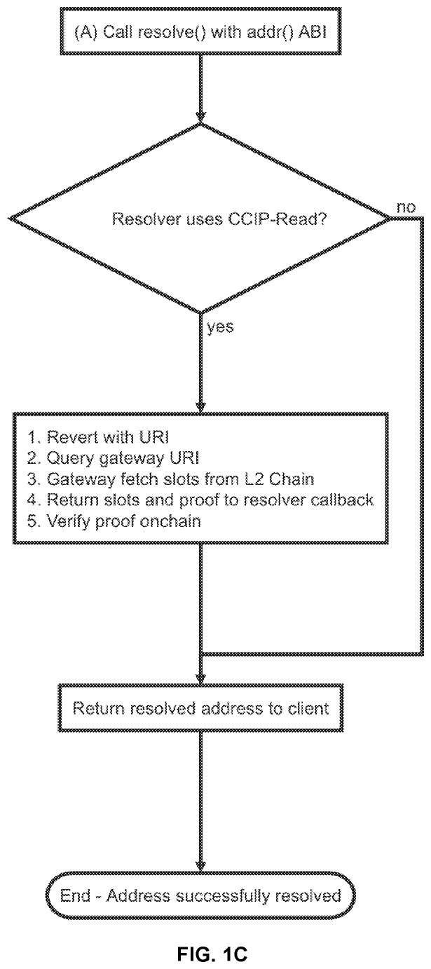

FIG. 2A shows the first image of two images showing the steps of resolving an ENS name using Unruggable Resolve, using an API, metadata and proofs.

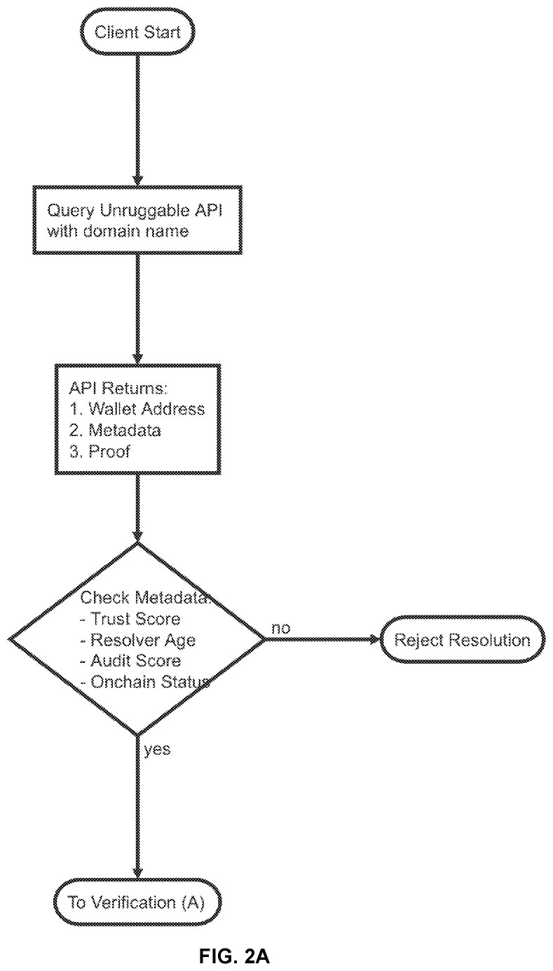

FIG. 2B shows the second image of two images showing the steps of resolving an ENS name using Unruggable Resolve, using an API, metadata and proofs.

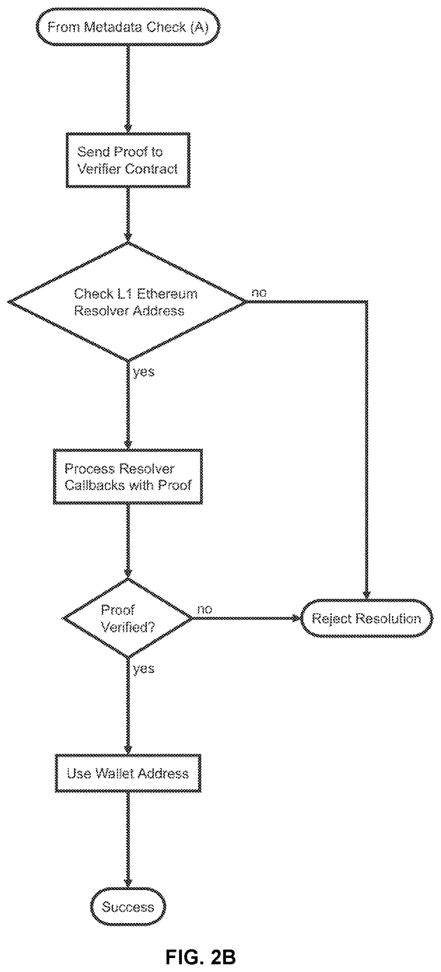

FIG. 3 shows a Verified AI Agent being used by a client.

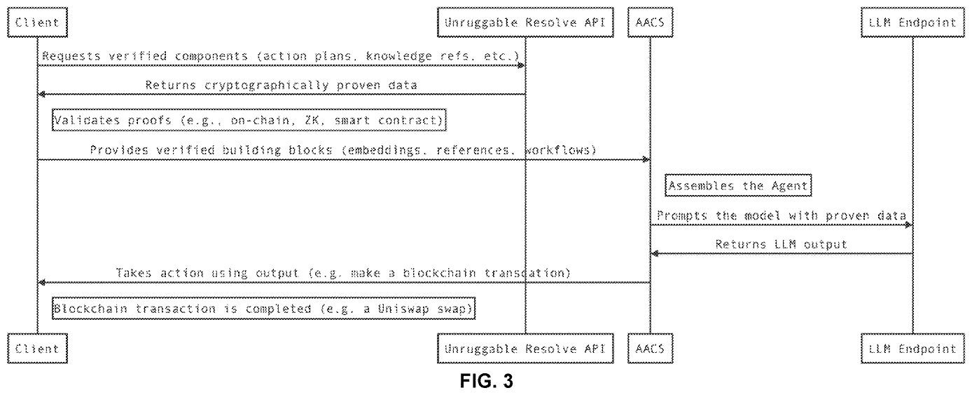

FIG. 4 shows two Verified AI Agents communicating together using an Agents Communication Platform.

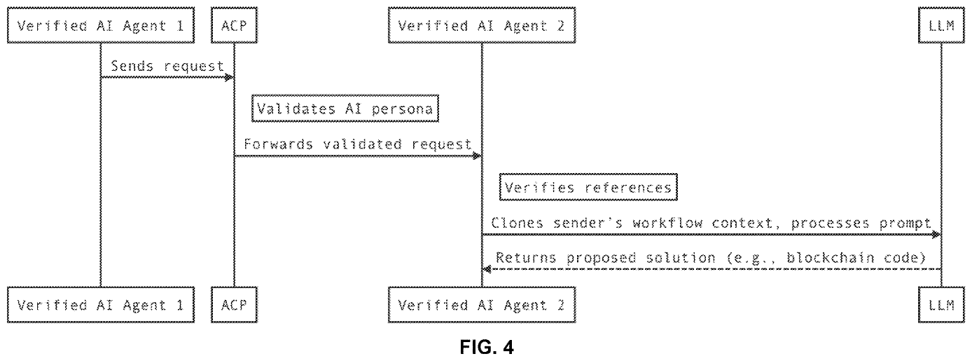

### DETAILED DESCRIPTION OF THE INVENTION

Unruggable Resolve provides an API endpoint that consolidates resolution for blockchain domain services, such as Ethereum Name Service (ENS). This unified endpoint simplifies integration for clients like wallets or DApps by handling diverse resolution methods across ecosystems. Each resolution may include metadata, which could include a trust assessment score calculated based on factors such as whether the resolver has passed independent audits, if the resolver is using proofs to fetch cross-chain data, and the age of the resolver. Clients can also request cryptographic proofs to independently validate the resolution on-chain or through local EVM-based client verification system, which could include a local EVM, light client, zk-proof verification, or even the generation of a zk-proof, using a remote service, or locally.

The system combines a closed-source core to protect the business model with open-source components like bridging logic for Layer 2 (L2) blockchain interactions to encourage adoption. It maintains a registry of resolvers that have passed independent security audits to prevent fraud. If a domain owner switches to an unrecognized or malicious resolver, the trust score flags the change, alerting wallets or DApps to potential spoofing. Domains can also embed multimedia references, such as images, audio, or video (e.g., IPFS hashes), with cryptographically signed metadata proving their origin. This approach ensures tamper-resistant provenance, countering the risks posed by AI-generated deepfakes and fostering a Verified Web.

Unruggable Gateways is a versatile framework for retrieving and verifying data from multiple blockchains, L2s, and off-chain sources. The system includes verifier contracts, an on-chain virtual machine (VM), and off-chain gateway servers that enable trustless data resolution using cryptographic proofs. This expands on the CCIP-Read (ERC-3668) standard, adding generalized proof verification suitable for L2s, sidechains, or off-chain databases.

Gateway servers operate off-chain, fetching data from target blockchains like Optimism, zkSync, Linea, and Base, or external sources like databases. These servers generate inclusion proofs, Merkle proofs, or zero-knowledge proofs that are verified on the origin chain by specialized contracts, such as SelfVerifier or chain-specific verifiers. By aligning with Ethereum's state-root commitments, the system ensures correctness and finality.

The lightweight VM processes Gateway Request objects-compact programs that specify operations like reading storage slots, applying offsets, retrieving hashed data, or performing nested evaluations. This flexibility allows developers to implement workflows that traverse struct fields, nested mappings, or multiple arrays in one pass. TrustedVerifier supports iterative testing by validating signed data, while production environments employ chain-specific verifiers to reconstruct and validate proofs securely.

When resolving “alice.l2.eth,” Unruggable Resolve determines that certain data (e.g., text records or proof-of-personhood credentials) resides on an L2 blockchain. It delegates the task to an Unruggable Gateway, which fetches the relevant storage slot, compiles a cryptographic proof, and sends it to an L1 verifier contract, or a local EVM instance. This capability extends to verifying multimedia provenance, such as validating an IPFS hash, or hash of an image, tied to a proof-of-personhood avatar, or executing complex cross-chain data retrieval for DeFi applications. ZK proofs can also be one or more of generated and verified, to verify credentials, such as “is over 18” without revealing the underlying private data, for example an age.

By ensuring cryptographic provenance for user content and interactions, this invention establishes a tamper-resistant Verified Web that supports real-time authenticity for names, credentials, and media.

A centralized website can provide detailed information on blockchain names, including metadata, audit records, trust scores, and AI Agent workflows. Users may access and verify blockchain names registered on networks like ENS, viewing records such as ownership details, on-chain metadata, and workflow components. For AI Agents, the site may display workflow diagrams illustrating triggers, data sources, and operational flows, enriched with metadata and cryptographic proofs. Trust scores and audit results can be prominently displayed, allowing users to assess the reliability and security of both blockchain names and AI Agents.

The site may also record the history of ENS name couplings to blockchain addresses, documenting changes over time. For example, if example.eth resolves to an address that has its primary name set to example.eth, this creates an ENS profile that can attribute on-chain actions, such as voting history, to the ENS name. Historical records ensure transparency, enabling users to see how ENS profiles evolve and appropriately include or exclude on-chain data when necessary.

Additionally, users may explore blockchain names through advanced search and filtering options, accessing metadata such as IPFS hashes, identity credentials, and proof-of-personhood records. For AI Agents, the site can display audit logs and interactive workflow visualizations. By combining metadata transparency, workflow visualization, and trust assessments, the website may provide a versatile tool for navigating and understanding the Verified Web.

Verified AI Agents are a cornerstone of the Verified Web, yet they do not exist as static or pre-compiled entities. Instead, clients dynamically assemble these Agents from verified components retrieved via services such as the Unruggable Resolve API, which returns cryptographically proven data. Each Agent is thus a sum of its parts-action plans, knowledge base references, chunks of contextual data, and workflows-all fetched from on-chain or off-chain sources with proofs. By validating these proofs (e.g., through a smart contract verifier or zero-knowledge proof mechanism), the client ensures that no malicious or untrusted data has been slipped into the Agent's context window.

Once the client has gathered the Agent's verified building blocks, it effectively “brings the Agent to life” using specialized AI Agent Client Software (AACS). This process is comparable to how a web browser constructs a dynamic web page from a multitude of URLs, API endpoints, and other resources (e.g., HTML, CSS, Javascript, images, and scripts). In the browser model, each piece of content—whether it is user interface elements, images, or embedded services—is loaded from distinct sources and integrated to present a coherent page. In the same vein, the AACS retrieves and integrates embeddings, knowledge base data, or API references from verified origins to assemble the Verified AI Agent. It then governs input parsing, orchestrates retrieval-augmented generation (RAG) calls, and safeguards output generation by requiring all critical data-such as a knowledge base reference or a trigger that initiates an action plan-to be proven authentic.

Crucially, the client also supplies the LLM endpoint, which could be a trusted API service (e.g., a private cloud API) or a locally running model on high-performance hardware (such as NVIDIA's DIGITS machine). Because the Agent relies on the client's own LLM resource, users retain control over the prompt and maintain full transparency of how their data is used and generated. Meanwhile, the Verified AI Agent's internal logic (e.g., task decomposition, chain of thought (CoT) reasoning, or the handling of intents and entities) remains traceable and auditable. Every step—be it an API call, a vector database lookup for chunks, or a stateful operation referencing a knowledge graph—can be hashed and cross-referenced against on-chain or cryptographically proven off-chain records.

This comprehensive approach prevents hallucination and malicious context injection that could instruct the Agent to perform unauthorized actions, such as diverting funds. Should the Agent encounter ambiguous requests or insufficient data, a fallback mechanism provides default behaviors. Throughout the workflow, feedback loops allow iterative improvements, and session state management preserves continuity across interactions. By situating the Verified AI Agent's assembly and execution at the client layer—much like a web browser dynamically loads and interprets pages from diverse APIs and URLs—the Verified Web ensures robust grounding, transparency, and security, enabling users to confidently harness powerful AI while preserving trust and integrity at every step.

In one embodiment, these workflows are stored on-chain, tied to the records of an ENS name. Each Verified AI Agent is represented with a unique identifier, such as agent12.nettech. eth, and an avatar or handle that serves as its public-facing identity. The agent's workflows, along with the potential paths these workflows can take, are hashed and stored on-chain as verifiable data.

AI Agents can autonomously interact with blockchain systems to execute transactions, interact with smart contracts, and update on-chain records, making them indispensable in areas like decentralized finance (DeFi), governance, and identity verification. For instance, an AI Agent managing a DeFi portfolio can retrieve real-time data from Layer-2 (L2) networks, validate it using cryptographic proofs, and autonomously rebalance funds or repay loans to prevent liquidation. These actions are immutably logged on the blockchain, ensuring transparency and auditability while building trust in the agent's decisions. To securely perform these tasks, AI Agents utilize advanced mechanisms like hardware wallets, secure enclaves (e.g., Intel SGX), and account abstraction wallets (e.g., ERC-4337) to sign transactions without exposing private keys.

Smart wallets enhance security further by enabling conditional access, allowing users to define operational limits for AI Agents. For example, a wallet can impose daily spending caps, restrict access to funds after a specific date, or require multi-signature approvals for critical transactions. These programmable constraints ensure that agents operate within predefined rules, safeguarding against unauthorized or excessive actions. Combined with immutable on-chain logging and cryptographic validation, these mechanisms allow AI Agents to securely and autonomously execute workflows like casting votes in decentralized governance, managing DeFi portfolios, or verifying credentials, while maintaining a balance of autonomy, accountability, and user control.

In addition to enabling trust-minimized operations within a single client environment, Verified AI Agents can also communicate and collaborate through an Agents Communication Platform (ACP)-an internet-connected software system that facilitates agent-to-agent interactions in a manner analogous to how users interact on social media platforms. Rather than exchanging multimedia content or GUI-rendered posts, these AI Agents share persona information (e.g., name, blockchain domain, metadata, credentials, attestations) and exchange structured data or prompts. The ACP can maintain each agent's online reputation by cataloging records of past actions, credentials, or membership affiliations. Agents may also host partial or full profiles on the ACP, reflecting their capabilities, knowledge base references, or action plans verified through on-chain or off-chain proofs.

Within the ACP, different categories of AI Agents (e.g., Verified AI Agents and trusted agents) can initiate dialogues by sending requests, messages, or data objects to one another. When a Verified AI Agent transmits a prompt or instruction, the receiving agent can use its AI Agent Client Software (AACS) to generate a partial or full clone of the sender's workflow context. This includes retrieving any relevant chunks of knowledge or proofs associated with the request. Because the sender's persona and context are anchored by the ACP in verifiable data structures (e.g., cryptographic hashes, zero-knowledge proofs, or on-chain records), the receiving agent can validate the authenticity of each input before feeding it into its local or cloud-based LLM. This approach prevents malicious injections—such as hidden instructions to divert funds —and ensures the output generation process is secure and grounded.

An illustrative scenario involves one Verified AI Agent seeking instructions from another on how to claim a blockchain airdrop. If the sending agent only provides a bare contract address, the receiving agent has no guarantee of its authenticity or safety. However, if the sending agent references one or more verified news sources or official blockchain announcements—packaged with cryptographic proofs of veracity—the receiving agent can confirm these references via the ACP. It then assembles a prompt, including the validated context, for a trusted AI system (e.g., a locally running LLM on NVIDIA's DIGITS machine).

The LLM, confident in the proven data, returns the precise blockchain transaction code to execute the airdrop claim. Through this trustless interaction, the ACP ensures that both AI Agents can reliably exchange instructions and data, fostering an ecosystem where verifiable reputations, metadata authenticity, and robust security measures enable seamless collaboration among diverse AI Agents.

Hashing is a foundational cryptographic process used to ensure the integrity and authenticity of digital content such as images, audio files, or documents. A cryptographic hash function, such as Keccak-256 (used in Ethereum), takes an input file and generates a fixed-length hash that uniquely represents the content. Any alteration to the file, even by a single bit, results in a completely different hash, making it a reliable method for verifying file integrity. In blockchain systems, a hash of a file can be stored in a smart contract. When the file is later presented, its hash can be recalculated and compared to the hash stored in the smart contract to confirm the file has not been tampered with. This process underpins the Verified Web by ensuring that users can trust the authenticity of digital assets and records.

Cryptography is at the heart of the Verified Web, enabling secure interactions and verifiable proofs. Elliptic Curve Cryptography (ECC) is widely used for digital signatures and key exchange due to its strong security and efficiency. It allows users to sign transactions or verify ownership of blockchain assets with minimal computational overhead. Zero-knowledge proofs (ZK proofs) provide a method for proving a statement is true without revealing the underlying data, enabling privacy-preserving verifications, such as proof-of-personhood or age validation. Hash functions like Keccak-256, SHA-256, and Poseidon are used for secure hashing and data integrity checks. By combining these cryptographic tools, the Verified Web enables a trustless, decentralized ecosystem where authenticity, privacy, and security are foundational principles.

A smart contract is a self-executing contract with the terms of the agreement directly written into code. These contracts operate on blockchain platforms such as Ethereum and execute predetermined actions when specific conditions are met. Smart contracts can be immutable and public, ensuring they cannot be altered after deployment and allowing anyone to use and trust them. A smart contract ABI (Application Binary Interface) defines the interface through which users or systems interact with a deployed contract. The ABI specifies the contract's functions, inputs, and outputs, enabling interaction via wallets, decentralized applications (DApps), or automated scripts. The immutability and transparency of smart contracts provide a foundation for trustless and decentralized systems.

The systems and methods described herein can be implemented using a combination of hardware and software. Hardware may include processors, memory, networking devices, and storage systems, while software refers to computer-readable instructions stored on non-transitory media. These instructions may be written in various programming languages, including but not limited to Solidity, Typescript, Python, and Java, and executed on diverse platforms such as cloud-based servers, decentralized blockchain networks, or mobile devices. The disclosed invention is not limited to specific hardware configurations, software architectures, or blockchain protocols, and is designed to remain adaptable to future advancements in technology, cryptography, and decentralized infrastructure.

The Verified Web is intended to be used in the context of any hardware device that can be connected to the internet. These devices include personal computing devices such as smartphones, tablets, laptops, and desktop computers, which are essential for accessing and interacting with web-based applications. It also extends to wearable technology like smartwatches, fitness trackers, and smart glasses, enabling seamless integration of digital and physical experiences. Smart home devices, including smart TVs, smart speakers, thermostats, and security cameras, are also part of this ecosystem, providing convenience and enhanced functionality in everyday living. Interactive robotic devices like home assistant robots, programmable drones, and AI-powered pet robots expand the scope further by offering dynamic and responsive interactions tailored to individual needs. Advanced technologies such as virtual reality (VR) and augmented reality (AR) headsets, drones, and gaming consoles create possibilities for immersive experiences and new modes of interaction. Industrial and specialized equipment like digital microscopes, AI-powered robotic arms, and smart lab devices demonstrate the potential for the Verified Web in scientific research and professional use cases. By supporting a vast range of devices, from everyday gadgets to highly specialized tools, the Verified Web aims to create a unified and secure environment for leveraging the power of verified AI agents, and secure blockchain naming technologies.

For purposes of this disclosure, references to a “Large Language Model (LLM)” are intended to be interpreted broadly. Any AI or computational system that accepts inputs-such as text, images, or audio-and returns outputs in various forms (including text, data, images, videos, or sounds) falls within the scope of the term “LLM” as used herein. This includes, but is not limited to, large foundational language models, smaller domain-specific models, machine learning inference engines, or other advanced AI mechanisms.

Moreover, the invention is not limited to any particular deployment environment for these AI systems. An “LLM” can be running in a public cloud service, on a private server, on an on-premises cluster, or even locally on a user's desktop computer or specialized hardware device (e.g., a GPU workstation). This broad definition ensures the invention remains agnostic to specific model architectures, deployment strategies, or underlying technologies, thereby encompassing the full spectrum of AI models and services.

### Example Use Cases

A wallet integration might call the consolidated API to resolve user profiles, retrieving unalterable data and preventing malicious resolver switching. A media marketplace might attach IPFS-hashed files to a chain record, with the gateway fetching data from different L2s and verifying no tampering occurred. A cross-chain ENS deployment might store partial metadata on a separate chain, with Unruggable Gateways securely fetching that data, returning it to L1, and proving authenticity. A DeFi protocol could confirm user collateral on an L2 vault, employing the system's verifiers to ensure accurate deposit amounts before allowing borrowing on L1.

### Computing and Implementation Considerations

The systems and methods described in this application may be implemented through a combination of hardware and software, with software referring to computer-readable instructions stored on non-transitory media, and hardware referring to devices that execute those instructions. Hardware components may include processors, memory units, networking interfaces, and specialized circuits such as ASICs (Application-Specific Integrated Circuits) or FPGAs (Field-Programmable Gate Arrays). Software components can consist of operating systems, middleware, application code, AI client software, and scripting frameworks, all of which may be developed in a range of languages (e.g., Solidity, Rust, Go, Java, Python, TypeScript, C++, or specialized AI frameworks) and deployed on platforms such as on-premises servers, cloud environments, local high-performance computing setups, or distributed networks.

In some embodiments, AI client software functions as a core interface for managing various proofs and verifications, including cryptographic proofs and trust assessments. For example, an AI agent or local inference engine may parse data, verify transaction integrity, or authenticate blockchain records—relying on hashing algorithms, zero-knowledge proofs, or other cryptographic methods. These verifications may be performed locally, within a user's environment, or in a decentralized manner utilizing blockchain nodes and RPC servers. Connections to blockchains can be established through any suitable means, including RPC endpoints, light clients, gateway nodes, or specialized hardware-based solutions; the underlying blockchain protocols may incorporate proof-of-work (PoW), proof-of-stake (PoS), zero-knowledge rollups, or other consensus mechanisms.

Blockchains operate as distributed ledgers of transactions and state transitions, anchoring data in tamper-resistant blocks linked by cryptographic hashes. While Ethereum is frequently cited, the invention is neither limited to Ethereum-based deployments nor to a single blockchain system. It can operate with or across any ledger technology—such as Bitcoin, Polkadot, Cosmos, or private and consortium networks. Additionally, hybrid or multi-chain architectures can integrate with diverse off-chain data sources, including centralized APIs, file storage systems (e.g., IPFS), or external databases.

Nothing in this disclosure should be construed as confining the invention to a specific embodiment. Each described component, from AI workflows and cryptographic verifiers to gateways and RPC interfaces, can be arranged in different configurations, distributed across multiple physical or virtual nodes, or consolidated in single nodes as required by the use case. Functionality such as proof generation, state synchronization, or AI-driven decision-making may similarly be delegated among various services or modules. This flexible, modular approach ensures interoperability and extensibility, accommodating evolving hardware, software, and cryptographic advancements. By supporting a wide spectrum of platforms and environments, the invention remains prepared to adapt to emerging technologies and seamlessly integrate AI, blockchain, and cryptographic capabilities.

What is claimed is:

1. A method of resolving a blockchain-based domain name via an API service that returns metadata and cryptographic proofs, the method comprising:
(a) receiving, at the API service, a resolution request identifying a blockchain-based domain name;
(b) determining that at least a portion of one or more domain records is stored on a different blockchain or off-chain source;
(c) retrieving the one or more domain records and media files via one or more gateway servers that generate one or more cryptographic proofs;
(d) assigning metadata, comprising one or more of a trust score, resolver modification date, whether the name uses off-chain resolution, and audited resolver status, to the one or more domain records and media files;
(e) returning, to a requesting client, both the one or more domain records and media files and the metadata;
(f) the client determining whether to resolve the one or more domain records and media files of the domain name based on the metadata; and
(g) the client resolving the one or more domain records and media files or terminating the resolution process.

2. The method of claim 1, further comprising the client verifying the proof to verify the one or more domain records and media files.

3. The method of claim 1, further comprising maintaining a registry of audited resolvers to detect and flag any unauthorized substitution of a resolver address, wherein such substitution triggers one or more actions including reducing the trust score and rejecting the resolution of the one or more domain records and media files.

4. The method of claim 1, wherein the proof includes one or more of zero-knowledge proofs, Merkle-based inclusion proofs, and signed attestations verified by specialized logic in the verifier.

5. The method of claim 1, wherein the one or more domain records and media files comprise user data comprising one or more of user profile credentials, proof-of-personhood, and user profile image, and further comprising verifying the user data to detect AI-generated deepfakes or content alterations by comparing hashes.

6. The method of claim 1, wherein the requesting client obtains a locally verifiable proof in addition to the one or more domain records and media files, allowing local-blockchain-client verification.

7. The method of claim 1, wherein the gateway servers implement ERC-3668 for cross-chain data retrieval from Layer-2 rollups.

8. The method of claim 1, further comprising calculating the trust score using one or more factors selected from the group consisting of: (i) the resolver's audit history, (ii) proof validation outcomes, and (iii) the date of the last change to the resolver; wherein the trust score is displayed on a website portal.

9. The method of claim 1, wherein malicious attempts to change the resolver to spoof a domain record result in one or more of reducing the trust score and the client not resolving the record.

10. The method of claim 1, further comprising verifying user data comprising one or more of age, nationality, and a credential using zero-knowledge proofs linked to the domain's on-chain records, thereby enabling selective access to offers or services based on proven credentials.

11. The method of claim 1, wherein the domain's trust score is dynamically updated in real time based on changes to on-chain records, newly detected security vulnerabilities, or proof-of-personhood credentials stored on a secondary blockchain, and displayed on a website portal.

12. An agentic system, the system comprising:
(a) a retrieval module configured to obtain AI agent workflow components from one or more on-chain or off-chain sources comprising at least one blockchain domain record, along with corresponding cryptographic proofs;
(b) a proof validation component that uses a verifier to validate the cryptographic proofs; and
(c) an AI agent client software used to assemble a verified AI agent from validated components and one or more AI foundation models, wherein the verified AI agent can be used to complete a multi-step task.

13. The agentic system of claim 12, wherein the assembled verified AI agent employs retrieval-augmented generation (RAG) by leveraging vector database entries or blockchain records to dynamically fetch and prove context for queries processed by a large language model.

14. The agentic system of claim 12, further comprising a fallback mechanism that deactivates or restricts the AI Agent if any component's cryptographic proof validation fails.

15. The agentic system of claim 12, wherein the AI Agent signs on-chain transactions using a private key of the client.

16. The agentic system of claim 12, further comprising an Agents Communication Platform (ACP) that facilitates AI agent-to-AI agent collaboration, wherein each agent's persona and workflow data are shared and cryptographically validated, ensuring authenticity before any new context is integrated.

17. The agentic system of claim 12, wherein the AI agent's chain-of-thought reasoning or step-by-step action logs are hashed and stored either on-chain or off-chain, enabling auditors to confirm the agent's decision-making process using cryptographic proofs.

18. The agentic system of claim 12, further comprising a real-time trust score update mechanism that modifies the AI Agent's trust score based on on-chain records, known vulnerabilities, feedback from other AI Agents in the ACP, or user-supplied evaluations, wherein the trust score is displayed on a website portal.

19. The agentic system of claim 12, wherein the AI Agent Client Software (AACS) integrates domain-specific knowledge graphs, external APIs, or specialized databases, each requiring verified references or proof-of-validity prior to use in the agent's context.

20. The agentic system of claim 12, wherein the cryptographic proofs for workflow components include zero-knowledge attestations that reveal no sensitive user data but confirm that certain access or membership criteria have been met.
